(19) United States
(12) Patent Application Publication
(10) Pub. No.: US 2024/0233687 A9
(43) Pub. Date: Jul. 11, 2024

(54) STRING FOR BOWED MUSICAL INSTRUMENTS

(71) Applicant: Mimmo PERUFFO, Caldogno (IT)

(72) Inventor: Mimmo PERUFFO, Caldogno (IT)

(21) Appl. No.: 17/618,125

(22) PCT Filed: Aug. 19, 2020
(86) PCT No.: PCT/IB2020/057787

§ 371 Date: Aug. 25, 2022

(30) Foreign Application Priority Data
Aug. 21, 2019 (IT) 10 2019 000014895

(51) Int. Cl. G10D 3/10; G10D 1/02

(52) U.S. Cl. CPC G10D 3/10; G10D 1/02

(57) ABSTRACT

A string (1) for bowed musical instruments (V) comprising a thread-like element (2) adapted to be applied to a sound box (C) and to a handle (M) of a bowed musical instrument (V) and comprising one or more filamentary fibers (3), made of synthetic material and placed under tension or tensioned so as to form a monofilament or multi-filament central core (4), and an outer thread (5) made of natural material, simply spirally wound around the central core (4) with which it is directly in contact.

The invention described relates to a string for bowed musical instruments, suitably placed under tension when mounted on chordophone musical instruments of the Western music tradition such as violins, cellos, violas, viols, double basses, harp and other medieval or ethnic instruments.

In other words, the current invention relates to a string which, when played by a bow of a musical instrument, returns an optimal sound which is pleasing to musicians.

As known, bowed instruments, more simply also referred to as strings, are chordophone musical instruments in which the vibration of the strings is stressed by a bow which is handled by the player and on which a bundle of horsehair is taught.

The rubbing of the bow on the string puts the latter into vibration, with frequency directly proportional to the square root of the tension and inversely proportional to the length and the square root of the linear density of the string itself.

The innovative particularity of the string for bowed musical instruments of the invention lies in that they consist of a composite assembly of multi-filament synthetic fibers or fiber elements (or in other words, filamentary bodies) and natural threads, combined with one another by means of a mechanical process which ensures significant structural stability.

It is also known that the musical instrument strings or musical strings used in the bowed musical instruments, especially for playing ancient music, are made of gut, a material in use since ancient times obtained by processing the intestinal tract of animals, for example ovine (rams, goats, lambs), and marked by a highly characteristic and personalized tonal performance combined with an excellent reactivity in contact with the horsehairs of the bow.

However, such a natural material has an increased cost (due to the manufacturing process, still predominantly manual, with which it is obtained and the availability thereof which is nonetheless regulated or reduced) and short life over time and therefore it is increasingly attempted to replace it with synthetic materials (among which the so-called “synthetic guts”).

Indeed, there have been many attempts over the last decades to replace natural gut strings with synthetic materials which provide the same sound, made in particular by the players of ancient music, but such attempts have always inevitably failed and been in vain.

In truth, there are synthetic string mounts for bowed musical instruments for ancient repertoires on the market, but they employ materials which generate a sound which is rather far from that of the natural product (gut).

Such string mounts are indeed much more similar to the modern mounts which are mainly made of metal, and therefore they are not appreciated by the more traditionalist and purist of players, especially those who play ancient music.

An example of strings for musical instruments made of alternative material to the simple animal gut is shown in the document of known art published under number EP2893950 A1, which discloses a composite string with a damping effect, consisting of a central core made of synthetic or natural material on which an outer thread is externally wound, the manufacturing material of which includes suitable metals and polymers such as synthetic and natural fibers: a viscoelastic polymer matrix is interposed between the central core and the outer thread, the viscoelastic polymer matrix comprising a binding and insoluble agent and nanoparticles at the solid state in such a binding agent.

Therefore, at the current state, within the field of bowed musical instruments, the natural material used for producing strings and appreciated by music players (not only, although especially, of ancient music but also of modern music) for the sounds it returns, is still not effectively replaced and not replaceable and has an increased sales price for the user and a rather reduced life to the point that on the one hand, it is often difficult, if not impossible, also for good and/or experienced players with reduced or only temporary economic resources to play pieces of ancient music, and on the other, it discourages beginners from approaching playing bowed musical instruments.

Therefore, the present invention intends fully remedying the drawbacks suffered by the current background art.

Therefore, in particular, it is a purpose of the current invention to provide a string for bowed musical instruments which is capable of basically faithfully replicating the sound of natural gut strings typical of the so-called ancient music, albeit while being made with a combination of materials alternative to the natural gut itself which, as mentioned, is currently the only one to provide guarantees in this respect.

In other words, it is the main purpose of the invention to provide a string for bowed musical instruments which has a lower sales price and a greater effective life as compared to the price and life of natural gut strings of the known type, respectively, while simultaneously ensuring sound levels which are similar, if not comparable and indistinguishable, with respect to the sound provided by the natural gut strings.

It is a further purpose of the current invention to indicate a string for bowed musical instruments which, although it is made of an alternative material to natural gut, allows the ultimate essence of the original and traditional sound provided by the natural gut string not to be destroyed.

It is another purpose of the present invention to fine-tune a string for bowed musical instruments which allows the use and the execution of ancient music pieces to be diffused, with particular reference to beginner players and amateurs.

It is a last but not least purpose of the invention to create a string for bowed musical instruments which may be quickly produced on a large scale.

Said purposes are achieved by a string specifically intended for bowed musical instruments as in appended claim 1, to which reference is made for the sake of disclosure brevity.

Further detailed operating features of the string for bowed musical instruments of the invention are contained in the respective dependent claims.

The invention also relates to the use of a composite thread-like element, having a minimal and essential composite construction concept, as specified in claim 1, as a string for bowed musical instruments, according to appended claim 10, to which reference again is made for the sake of disclosure brevity.

The aforesaid claims, hereinafter specifically and concretely defined, are intended as an integral part of the present description.

Advantageously, the string for bowed musical instruments of the invention has a much higher breaking load than that of strings made of gut of the prior art used for the same purpose, which often experience sudden breaks which are obviously undesirable for the final user, due to the fact that the gut is a natural material subject to many unpredictable variables which are not easily controlled.

Just as advantageously, the string for bowed musical instruments of the current invention has a moisture absorption which is about three hundred times lower than that of a natural gut string: this translates into great stability in maintaining the tuning of the musical instrument provided by the strings of the invention, an aspect which is increasingly critical with the strings of natural gut which are rather hygroscopic, thus making the possible musical execution in public and/or outdoors problematic.

Again advantageously, the string for bowed musical instruments of the present invention generates a sound which is almost indistinguishable from a string made of gut, however with the advantage of being made of materials which are more readily available in nature and in return, having an end sales price which is lower than that of a natural gut string.

Equally advantageously, the sound quality provided by the string of the current invention is also competitive with respect to the common steel strings already used in bowed musical instruments.

All of this is due to the fact that in the string for bowed musical instruments of the invention, the thread-like element distinguishing it includes a plurality of filamentary fibers, each made of synthetic material (better known in jargon with the term “multi-filament” or “yarn”) and placed under tension or tensioned so as to form a central monofilament or multi-filament core, and an outer thread made of natural material preferably such as spirally wound cotton, with turns preferably but suitably placed side-by-side, around the central core of filamentary fibers previously placed under tension.

Despite this construction concept being in some ways comparable (albeit remotely) to that used not only for making the strings for bowed musical instruments (in this regard, see prior art document EP2893530 A1), but also the bass strings of a guitar, it is worth noting that strings with the covering provided by the invention (the outer thread made of natural material, in particular cotton) are not at all on the market of the strings for ancient music: this is a confirmation of the highly innovative nature of the string of the invention because if, with the proven optimal sound and mechanical features thereof, it were already acquired by the prior art, the need—which instead is still alive and concrete—which for at least half a century has been affecting the players of ancient music—would already have been met and no longer felt by them.

After lengthy experimentation and several related tests, the applicant succeeded in developing a type of string for musical instruments, which had not yet even been hypothesized by the known art, which completely achieves the objective of replacing the natural gut and of departing from prior document EP2893530 A1 with a more affordable alternative composite material which is more performing in terms of the useful and effective life, without this resulting in a worsening of the sound which may be obtained, to such a point that it is not feasibly possible to distinguish the sound of a natural gut string from that of the string of the invention, not even by an experienced and/or demanding player.

Therefore, the applicant has surprisingly succeeded in getting an effective and advantageous result by following a design tradition which to date has never been considered by other operators in the field, i.e. making a plastic string (or thread) playable by a bow which otherwise would in no way be capable of generating a tone which is even only acceptable because the horsehairs of the bow would slide thereon: this using the technical artifice of simply winding an outer thread made of natural fiber material such as cotton (preferred raw material) or silk around a monofilament or multi-filament central core made of synthetic material without suitably interposing any binding agent between the central core and outer thread.

The string for bowed musical instruments of the current invention therefore produces an unexpected technical effect in the field at hand, and as is known, this is to be considered as an indication of the presence not only of novelty but also of inventive value in the object being exclusively claimed herein: such a technical effect surprisingly results from the object as claimed and is based on the main, essential and indispensable technical features of the invention, combined with the known features.

In the invention, such a technical effect is not suitably based on technical features which, combined, are already included in the prior art because the use of natural fiber materials, selected from cotton (optimal and preferred solution) and silk, to make the outer thread which spirally covers the monofilament or multi-filament central core, provided with one or more fibers which have been previously placed under tension and are made of synthetic material, to date has never been provided and implemented in the field involved, as also shown by prior document EP2893530 A1.

The aforesaid purposes and advantages, as well as other ones which will emerge later, will become more apparent from the following descriptions related to a preferred embodiment of the string for bowed musical instruments of the invention, given indicatively by mere way non-limiting example, with the aid of the accompanying drawings, in which:

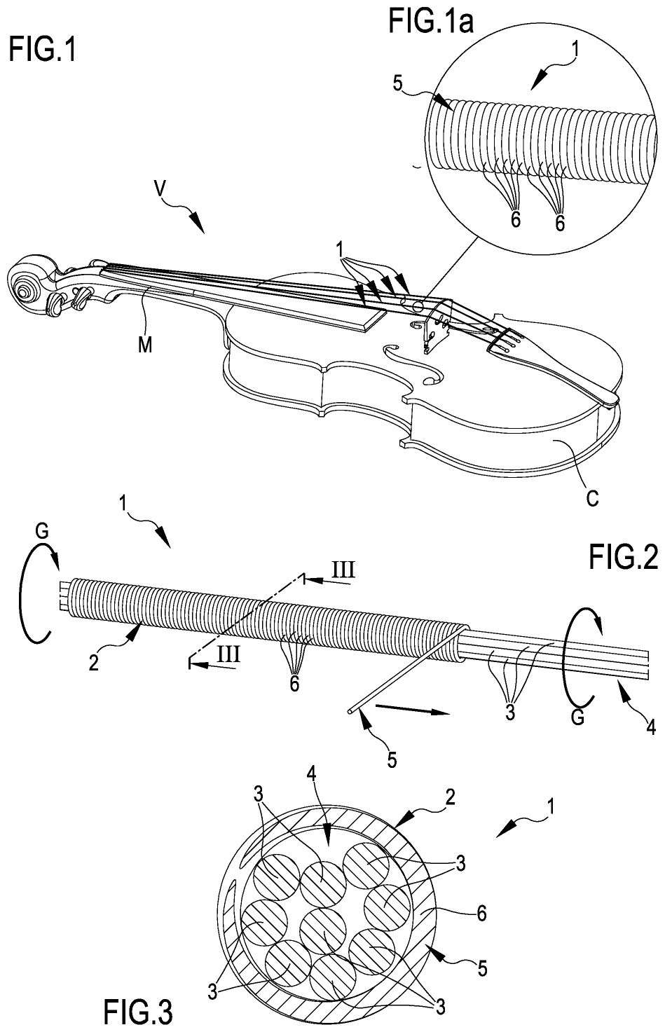

FIG. 1 is an axonometric view of a series of strings for musical instruments for bows according to the technical teachings of the invention under application conditions, applied to a sound box and a handle of a typical violin;

FIG. 1a is an enlarged detail in FIG. 1, related to a section of the string of the invention;

FIG. 2 is an exemplified axonometric view of the string in FIG. 1, in assembly step;

FIG. 3 is a view of FIG. 2 according to the section plane III-III.

The string for bowed musical instruments, such as the violin shown in FIG. 1 where it's indicated as a whole by V, is numbered as a whole by 1 in the following drawings.

As noted, string 1 comprises a composite thread-like element 2 adapted to be applied to a sound box C and to a handle M of the bowed musical instrument V.

In this specific case, the composite thread-like element 2 comprises a plurality of filamentary fibers 3 (otherwise definable as plurality of multi-filaments or again, as plurality of fiber elementary filaments), each made of synthetic material placed under tension or tensioned so as to form a central core 4 of compact microfilaments.

Moreover, the composite thread-like element 2 comprises an outer thread 5 made of natural material which, according to the invention, is arranged externally to and directly in contact with the central core 4 of the filamentary fibers 3, around which it is simply resting and spirally wound without any interposition of binding agents, impregnating agents or glues between the central core 4 and the outer thread 5.

What is more, as provided for example by prior document EP2893530 A1, such binding agents, impregnating agents or glues expressly have a damping effect which is entirely contrary to what string 1 of the invention is set to do, the declared and main object of which is instead that of decidedly and apparently improving, as compared to the current state of the art, the tone returned by a string having a central core made of plastic material, when played by the horsehair of a bow.

The tensioned filamentary multi-filament fibers 3 preferably are arranged side-by-side and parallel to one another when placed under tension, as shown in FIG. 3.

Furthermore, the tensioned filamentary multi-filament fibers 3 substantially and suitably have the same length.

Preferably but not exclusively, the synthetic material with which the filamentary fibers 3 are made is any among the polymer materials selected from the group consisting of polyester, aliphatic polyamide (also known by the trade name of Nylon, for example in the variants 6 or 6.6), aromatic polyamide, organic thermoplastic polymer, such as in particular polyether ether ketone (known also by the acronym PEEK) and/or combinations thereof.

The above expression “combinations thereof” means that in certain embodiments of the string of the invention (not shown), certain filamentary fibers could be made of a given synthetic material, e.g. polyester, while certain others could be made of a different synthetic material, such as Nylon and/or PEEK.

Generally and preferably in any case, the filamentary fibers 3 are all made of the same synthetic material, being obtained from the same reel or skein, and are mutually monolithic.

The central core 4 of multi-filaments 3, that once formed is a kind of multi-filament rod made of plastic material, has increased density and a thickness (notably, a diameter) in the range of 1,000 to 40,000 decitex (dtex, abbreviated), inside which it varies from one execution to another according to the type of musical instrument. More preferably, the value of such a thickness (i.e. the diameter) of said multi-filament central core 4 (or filamentary fibers 3) is in the range of 1,400 to 30,000 decitex (dtex).

With regard to the outer thread 5, the enlarged detail in FIG. 1a and FIG. 2 show that it is wound on the central core 4 of multi-filaments 3 (or microfilaments or “yarn”) so that the turns 6 of the outer thread 5 itself are perfectly side-by-side, adjacent to one another, one against the other.

According to the preferred embodiment herein described of the invention, the natural material with which the outer thread 5 is made and which uniformly covers the central core 4 is, in a completely innovative and surprisingly effective manner for the field, any one of the natural fiber materials selected from the group consisting of cotton (preferred solution) and silk.

Alternative but less frequent and less performing solutions of the string of the invention provide for the natural fiber material of the outer thread to be selected from the group consisting of hemp, linen, jute, ramie, sisal (or Agave sisalana) and/or combinations thereof.

The outer thread 5 used in the invention is of the plied type and is commonly also referred to “stitching thread”.

The value of thickness (notably, the diameter) of the outer thread 5 preferentially is in the range of 10 to 100 decitex (dtex, abbreviated).

In a preferred but non-constraining manner, the value of thickness of the outer thread 5 is equal to 50 decitex (dtex).

For the sake of argumentative completeness and conscientiousness, the term “tex” means a measure unit for the linear density corresponding to one gram per kilometer (for example, of thread, yarn or filamentary fiber, as also identified above): this measure unit is used in the textile field for the titration of textile fiber.

More commonly, the “decitex” (dtex, abbreviated), which corresponds to 1 gram for each 10 kilometers, is used for measuring the aforesaid linear density. So, for example, 500 dtex means 10 kilometers of the central core 4 of multi-filaments 3 weighs exactly 500 grams.

The object of the present invention also extends to using the thread-like element 2 as defined above (in particular, in the general composition thereof given by the central core 4 of synthetic filamentary fibers 3 and by the natural outer thread 5) as string 1 for bowed musical instruments (chordophones), such as violin V in FIG. 1, for example.

The assembly of the preferred solution of string 1 for bowed musical instruments V of the current invention is partially shown and in any case may be clearly inferred from FIG. 2, where the central core 4 of multi-filaments—consisting of the parallel filamentary fibers 3—placed under tension between two hooks and the outer thread 5 continuously winding on such a central core 4 due to the simultaneous effect of the automatic rotation thereof—for example in clockwise direction according to the direction given by arrow G, obtained in a thread winding machine of the type known per se to those skilled in the art—from a reel or skein (not shown, in the case of filamentary fibers 3) and from a respective spool or stitching thread on a spool (not shown).

In a particular and preferred manner, the parallel arrangement of the filamentary fibers 3 occurs by winding a continuous synthetic thread made of multi-filament fiber around the two spaced apart hooks for the preset number of times required for the type of string (of the multi-filament type) to be obtained from reel or skein.

According to the above description, it is understood that the string for bowed musical instruments of the present invention and the use of a composite thread-like element as a string for bowed musical instruments achieve the purposes and reach the advantages mentioned above.

It is reiterated that the solid contact of the bow with the string of the invention, belonging to chordophone musical instruments such as, for example violins, cellos, violas or double basses, has revealed to be surprisingly optimal, to the point that it generates a substantially comparable sound to that of a string made of the traditional natural gut, therefore being appreciable and appreciated not only by the most demanding, experienced and traditionalist players who play ancient music, for example, but unexpectedly also by those playing modern musical repertoires: the strings of the current invention are therefore competitive in terms of performance also in relation to the common metal strings (such as steel) currently widely used in bowed musical instruments due especially to the specific natural material with which the outer thread advantageously is made.

Not only is this to the advantage of easier access to using such musical instruments, for example and conventionally for playing ancient music, by persons having more limited economical resources and which generally live in less rich countries, such as those in South America or Eastern Europe, but it also serves as an encouragement for those people approaching playing such bowed musical instruments as beginners and who instead generally are easily discouraged when faced with the prohibitive price (at least for them) and the short life over time of the traditional natural gut strings.

The string for bowed musical instruments of the present invention indeed has a lower cost and increased life as compared to a traditional string of equal use, made of natural gut, while however ensuring the sounds of the past to be recalled or reconstructed, which sounds are typical of ancient music and cannot be obtained with strings made of metal material (such as steel), which are only adapted to modern music.

Additionally, the string for bowed musical instruments of the invention has a much simpler (and therefore more affordable) construction concept than the string for musical instruments described in the prior art document EP2893530 A1, in which no specific example is provided for the plant material with which the outer thread which covers the composite central core is made and which, as noted above, due to the construction concept thereof which provides a viscoelastic binding agent between the outer thread and the central core, has the objective of eliminating the acute sound tones (or those with the highest frequencies), teaching in substantially opposite direction to that of the string of the invention which instead sets to make a plastic material string playable in an effective manner, to the point that when played, it generates a sound comparable to and almost indistinguishable from that of a gut string.

Upon execution, significant changes could be made to the string for bowed musical instruments of the invention—for instance a different number of filamentary fibers from those shown in the accompanying drawings while recognizing that such a number may vary freely—according to the application needs and/or construction choices, starting from two.

In addition to this, the string for bowed musical instruments in other embodiments of the invention (not shown below) may include a single filamentary fiber made of synthetic material so as to form a monofilament central core.

Finally, it is apparent that many other changes could be made to the string for bowed musical instruments concerned, without departing from the principles of novelty inherent in the inventive idea, as it is apparent that in the practical implementation of the invention, the materials, shapes and sizes of the details shown may be any according to the requirements and may be replaced by other technically equivalent elements.

Where the constructional features and techniques mentioned in the following claims are followed by reference signs or numerals, such reference signs were introduced for the sole purpose of increasing intelligibility of the claims themselves, and therefore such reference signs have no limiting effect on the interpretation of each element identified merely by way of example only by such reference signs.

1. A string for bowed musical instruments including a composite thread-like element adapted to be applied to a sound box and to a handle of a bowed musical instrument, said composite thread-like element comprising:
a plurality of tensioned filamentary fibers, made of synthetic material, arranged side-by-side and parallel to one other when placed under tension so as to form a multi-filament central core;
an outer thread made of natural material, spirally wound around said central core of said filamentary fibers and arranged externally and directly in contact with said central core of said filamentary fibers,
wherein said filamentary fibers forming said multi-filament central core, around which said outer thread is only resting and wound without any interposition of binding agents, impregnating agents or glues between said central core and said outer thread, are straight and said natural material with which said outer thread is made is cotton.

2. (canceled)

3. The string according to claim 1, wherein said tensioned filamentary fibers have substantially the same length.

4. The string according to claim 1, wherein said synthetic material of which said filamentary fibers are made is any among the polymer materials selected from the group consisting of polyester, aliphatic polyamide, aromatic polyamide, organic thermoplastic polymer and/or combinations thereof.

5. The string according to claim 1, wherein said multi-filament central core has a thickness of value in the range of 1,000 to 40,000 decitex (dtex).

6. The string according to claim 4, characterized in that said value of said thickness of said multi-filament central core is in the range of 1,400 to 30,000 decitex (dtex).

7. The string according to claim 1, wherein said outer thread is wound on said central core so that the turns of said outer thread are placed side-by-side.

8. The string according to claim 1, wherein the value of thickness of said outer thread is in the range of 10 to 100 decitex (dtex).

9. The string according to claim 1, wherein said value of thickness of said outer thread is equal to 50 decitex (dtex).

10. Use of a composite thread-like element according to claim 1 as a string for bowed musical instruments.
